(19) United States
(12) Patent Application Publication
(10) Pub. No.: US 2015/0373194 A1
(43) Pub. Date: Dec. 24, 2015

(54) METHOD AND APPARATUS FOR NOTIFICATION OF MULTIPLE TELEPHONY DEVICES

(71) Applicant: VONAGE NETWORK, LLC, HOLMDEL, NJ (US)

(72) Inventors: ZHIYU GUO, EAST BRUNSWICK, NJ (US); WEIPING GUO, HILLSBOROUGH, NJ (US); DENNIS BUSH, Hamilton, NJ (US); KAI XIN, EAST BRUNSWICK, NJ (US); KEVIN HUANG, PRINCETON JUNCTION, NJ (US); BOAZ ZEHAVI, JERSEY CITY, NJ (US)

(21) Appl. No.: 14/309,648

(22) Filed: Jun. 19, 2014

(51) Int. Cl. H04M 3/46; H04M 1/247; H04M 7/00

(52) U.S. Cl. CPC H04M 3/46; H04M 7/0075; H04M 1/2477

(57) ABSTRACT

The Internet Protocol telephony system comprises a registration unit; a signal handling interface; a rules engine; and a call processing interface. The registration unit is configured to store, in association with a customer record, a notification list of one or more telephony devices that that are to be notified upon receipt by the Internet Protocol telephony system of a communication addressed to a customer identifier corresponding to the customer record. The signal handling interface is configured to receive a signal originated by a telephony device. The rules engine is configured to consult the notification list and apply rules logic to determine in what order the one or more telephony devices on the notification list are to be notified. The call processing interface is configured to route notifications to the one or more telephony devices.

### TECHNICAL FIELD

The technology relates to telecommunications, and particular to Internet Protocol (IP) telephone systems.

### BACKGROUND

A telephone subscriber generally has one or more telephony devices which are served by a home carrier and which are associated with a nominal telephone number, such as a directory number. The directory number generally corresponds to an account for the subscriber. Telephonic communications emanating or originating from a telephony device of the subscriber as a calling party (e.g., outgoing communications) are generally routed by the calling party's home carrier through one or more switches, and possibly networks of other carriers, to a called party. The called party may be a subscriber of the same or of another home carrier. Conversely, telephonic communications destined for the telephony device of the called telephone subscriber (e.g., incoming communications) are routed on the basis of, e.g., the nominal telephone number, through switches to the called party's home carrier so that the communications may be “terminated” at the called party, i.e., the telephone subscriber.

In some instances in which the telephony device is an analogue device, the communications involving the telephone subscriber may be initiated as analogue communications and thereafter may be adapted for packet transmission. In other cases the telephony device may be a data packet-compatible device, such as an Internet Protocol (IP) device, so that the communication is essentially entirely packet-based. In either case, Internet Protocol telephony systems have been provided to route various types of communications, at least in part, via data packets that are communicated over a data network. The data network is commonly the Internet. The types of communications may be, for example, telephone calls, video calls, text and video messages, and other forms of telephony and data communications.

In some instances an outgoing communication may be routed at the subscriber's request to the Internet Protocol telephony system, so that the communications may be completed or “terminated” by the Internet Protocol telephony system. Some users or subscribers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in wired manner to the respective access point.

Other users or subscribers of the IP telephony system may possess mobile or wireless telephony devices, such as a wireless terminal, user equipment (UE), mobile phone, smart phone, or laptop, tablet, or other device with mobile termination. Nowadays some telephony services including IP telephony systems provide computerized applications that may be downloaded to a mobile telephony device. Upon login to such mobile telephony applications (e.g., with user name and password) the mobile telephony device user may at least temporarily register the mobile telephony device with the Internet Protocol telephony system.

When such a mobile telephony device is within coverage of an appropriate wireless access network (e.g., WiFi or WiMAX network) that has connection to the data network, the communications involving the mobile telephony device may be handled by the IP telephony system in conjunction with the wireless access network. In other words, the communications may occur wirelessly between the mobile telephony device and a wireless access point of the wireless access network, with the wireless access point in turn being connected to an Internet portal. Typically the wireless connection of the mobile telephony device to the wireless access point is over unlicensed radio frequency resource(s). Access in this manner to the Internet portal enables the mobile telephony device to capitalize upon the service of the IP telephony system in economically routing the communications through the Internet, rather than over existing non-Internet service carriers, e.g., over a mobile radio access network.

When a mobile telephony device is not in range of a wireless access network and accordingly not able to gain the benefit of the IP telephony service, the mobile telephony device may instead be served by other carriers/services using one or more mobile radio access networks. Such mobile radio access networks typically comprise plural base stations which have both radio frequency transmitting and receiving capabilities to serve macro cells and typically use licensed frequency resource(s), such as GSM type mobile networks. A macro cell is essentially defined by the extent of the transmitting and receiving capabilities of the base station. The mobile telephony devices located within the cell may communicate with the radio access network through the base station (unless the customer also happens to be within range of another wireless network, such as a WiFi wireless network or the like, and exercises the option to use the other wireless network instead of the radio access network). In some instances such a “macro” base station may be called a “radio base station”, “base station”, NodeB, eNodeB, or the like.

Many people have lifestyles and/or careers that involve considerable if not extreme mobility. For example, an increasing number of professional persons now work both at home and the office, sometimes with unpredictable timing Others may divide their time between several business offices, e.g., between a main office and a branch office. Even in the private sector mobility abounds, with many persons having two or more residences, such as vacation homes, or splitting time between their own residence and that of a relative. A service known as “call forwarding” is very useful for mobile telephony customers. Call forwarding enables a telephony customer to have a call addressed to a certain address, e.g., a nominal or directory number, be routed instead to another telephony address. Some telephone services provide another feature which in which multiple telephones may be rung, either simultaneously or in sequence, in response to the dialing or entry of a single number.

Traditionally, activation of modification of the devices to be rung is through a user interface such as a website provided by the telephony service. Such interface generally creates a static set of conditions (forwarding number(s) or order of devices to attempt to forward the call to). But in some instances the telephony customer may have reason for notification of the incoming call to be provided under changing conditions or a more flexible set of conditions. For example, during a day when a professional person is “in and out” of the office he/she may want communications incoming to the office telephony device to ring both at the office telephony device and the customer's mobile telephony device , and perhaps in specific order based on user preference or which device is more accessible.

For reasons described above there is a need in the art for the dynamic population or enumeration of telephony devices in a multiple device ring notification list including mobile device interaction service.

### SUMMARY

In one of its aspects the technology disclosed herein concerns an Internet Protocol telephony system. The Internet Protocol telephony system comprises a registration unit; a signal handling interface; a rules engine; and a call processing interface. The registration unit is configured to store, in association with a customer record, a notification list of one or more telephony devices that that are to be notified upon receipt by the Internet Protocol telephony system of a communication addressed to a customer identifier corresponding to the customer record. The signal handling interface is configured to receive a signal originated by a telephony device. The rules engine is configured to consult the notification list and apply rules logic to determine in what order the one or more telephony devices on the notification list are to be notified. The call processing interface is configured to route notifications to the one or more telephony devices.

In an exemplary embodiment and mode the signal handling interface is configured to receive a signal originated by a computer application executed at a telephony device. In an exemplary embodiment and mode, the signal is configured to control the notification list. In an exemplary implementation the signal requests that the notification list be modified with respect to the telephony device. The rules engine is configured to consult the notification list and to apply the rules logic upon receipt by the Internet Protocol telephony system of the communication addressed to the customer identifier corresponding to the customer record.

In an exemplary embodiment and mode the signal is configured to add the telephony device to the customer record.

In an exemplary embodiment and mode the signal is configured to control the notification list. In an exemplary embodiment and mode the signal is configured to request one of the following: (1) that the telephony device be included on the notification list; (2) that the telephony device be removed from the notification list; and (3) that a ranking order of the telephony device on the list be modified.

In an exemplary embodiment and mode the rules logic requires that the one or more telephony devices be essentially simultaneously notified.

In an exemplary embodiment and mode the rules logic requires that the one or more telephony devices be notified sequentially in accordance with ranking order information respectively associated with the one or more telephony devices on the notification list.

In an exemplary embodiment and mode at least one or more of the registration unit, the signaling handling interface, the rules engine, and the call processing interface are implemented by a computer processor.

In another of its aspects the technology disclosed herein concerns a telephony device which comprises a processor and an interface. The processor is configured to generate a signal configured to control a notification list maintained by an Internet Protocol telephony system with respect to the telephony device, the list being of one or more devices that are to be alerted upon receipt by the Internet Protocol telephony system of a communication addressed to a particular customer identifier. The interface is configured to transmit the signal to the Internet Protocol telephony system.

In an exemplary embodiment and mode the signal is further configured to add the telephony device to a customer record associated with the particular customer identifier.

In an exemplary embodiment and mode the signal is configured to prompt the Internet Protocol telephony system to perform a modification of the list. In an exemplary implementation, the signal is configured to prompt the Internet Protocol telephony system to perform a modification of a list with respect to the telephony device. The notification list is of one or more devices that are to be alerted upon receipt by the Internet Protocol telephony system of a communication addressed to a particular customer identifier.

In an exemplary embodiment the modification is one of the following: (1) including the telephony device on the notification list; (2) removing the telephony device from the notification list; and (3) changing a ranking order of the telephony device on the list.

In an exemplary embodiment the interface is a transceiver configured to transmit the signal to a wireless access point which is in data communication with the Internet Protocol telephony system and, after the telephony device has been included on the list, to receive an incoming communication addressed to the particular customer identifier.

In an exemplary embodiment the telephony device further comprises a user interface, and the processor is configured to execute a computer application comprising instructions stored on non-transient computer-readable medium. The user interface facilitates user interaction with the application. In an exemplary implementation the processor is configured to include computer application authentication information in the signal. In an exemplary implementation the processor is configured to register the computer application authentication information with the Internet Protocol telephony system upon installation of the computer application. In an exemplary implementation the user interface is configured to request notification option information from the user, and the processor is configured to include the notification option information in at least one or more of the signal and another signal to the Internet Protocol telephony system. In an exemplary implementation the notification option information includes an indication of ranking order of the telephony device on the list. In an exemplary implementation the processor is configured to receive a constituency of other telephony devices already included on the list and to provide the constituency to the user on the user interface, and to receive through the user interface an indication of ranking order of the telephony device relative to the constituency of other telephony devices.

In another of its aspects the technology disclosed herein concerns a method of operating a communications network via an Internet Protocol telephony system. The method comprises receiving a signal generated by a telephony device, the signal configured to control a notification list, the notification list being of one or more telephony devices that are to be alerted upon receipt by the Internet Protocol telephony system of a communication addressed to a particular customer identifier. The method further comprises, upon receipt of the signal, performing the modification of the notification list in accordance with the request. The method further comprises, upon receipt of the communication addressed to the particular customer identifier, routing a notification of the communication to one or more telephony devices on the notification list.

In an exemplary embodiment and mode the signal is configured to prompt modification of the notification list. In an exemplary embodiment and mode the modification is one of the following: (1) including the telephony device on the notification list; (2) removing the telephony device from the notification list; and (3) changing a ranking order of the telephony device on the notification list.

In an exemplary embodiment and mode the signal is configured to request one of the following: (1) that the telephony device be included on the notification list; (2) that the telephony device be removed from the notification list; and (3) that a ranking order of the telephony device on the list be modified.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1A is a diagrammatic view of an exemplary communications network in which multiple device ring notification may be performed for a wireless telephony device.

FIG. 1B is a diagrammatic view of an exemplary communications network in which multiple device ring notification may be performed for a telephony device connected by wire to a data network.

FIG. 2 is a schematic view illustrating example functionalities and or units comprising a non-limiting exemplary embodiment of a Internet Protocol telephony system according to an exemplary embodiment.

FIG. 3A is a schematic view illustrating example functionalities and or units comprising a non-limiting exemplary embodiment of a wireless telephony device according to an exemplary embodiment.

FIG. 3B is a schematic view illustrating example functionalities and or units comprising a non-limiting exemplary embodiment of a wired telephony device according to an exemplary embodiment.

FIG. 4A and FIG. 4B are diagrammatic views of an example multiple device ring notification list for an example customer at differing points in time.

FIG. 5 is a flowchart illustrating basic exemplary acts or steps comprising a notification list modification procedure in accordance with an exemplary embodiment and mode.

FIG. 6 is a diagrammatic view of at least a portion of an example customer record which shows another technique for maintaining a multiple device ring notification list.

FIG. 7 is a diagrammatic view of at least a portion of an example customer record which shows another technique for maintaining a multiple device ring notification list including ranking order information respectively associated with the one or more telephony devices on the notification list.

FIG. 8A and FIG. 8B are diagrammatic views showing example screen formats that may be displayed on an example telephony device for obtaining notification option information.

FIG. 9 is a flowchart illustrating basic exemplary acts or steps comprising an incoming communication processing procedure performed by an internet-based telephony system in accordance with an exemplary embodiment and mode.

FIG. 10 is a schematic view shows an example of machine hardware comprising one or more processors for implementing aspects of an IP telephony system and a wireless telephony device according to exemplary embodiments.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In the following description, the terms “VoIP system,” “VoIP telephony system,” “IP system” and “IP telephony system” are all intended to refer to a system that connects callers and that delivers data, text and video communications using Internet protocol data communications.

The following description will refer to “telephony communications.” The term “telephony communications” is intended to encompass any type of communication that could pass back and forth between users of an IP telephony system. This includes audio and video telephone, text messages, video messages and any other form of telephony or data communication.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

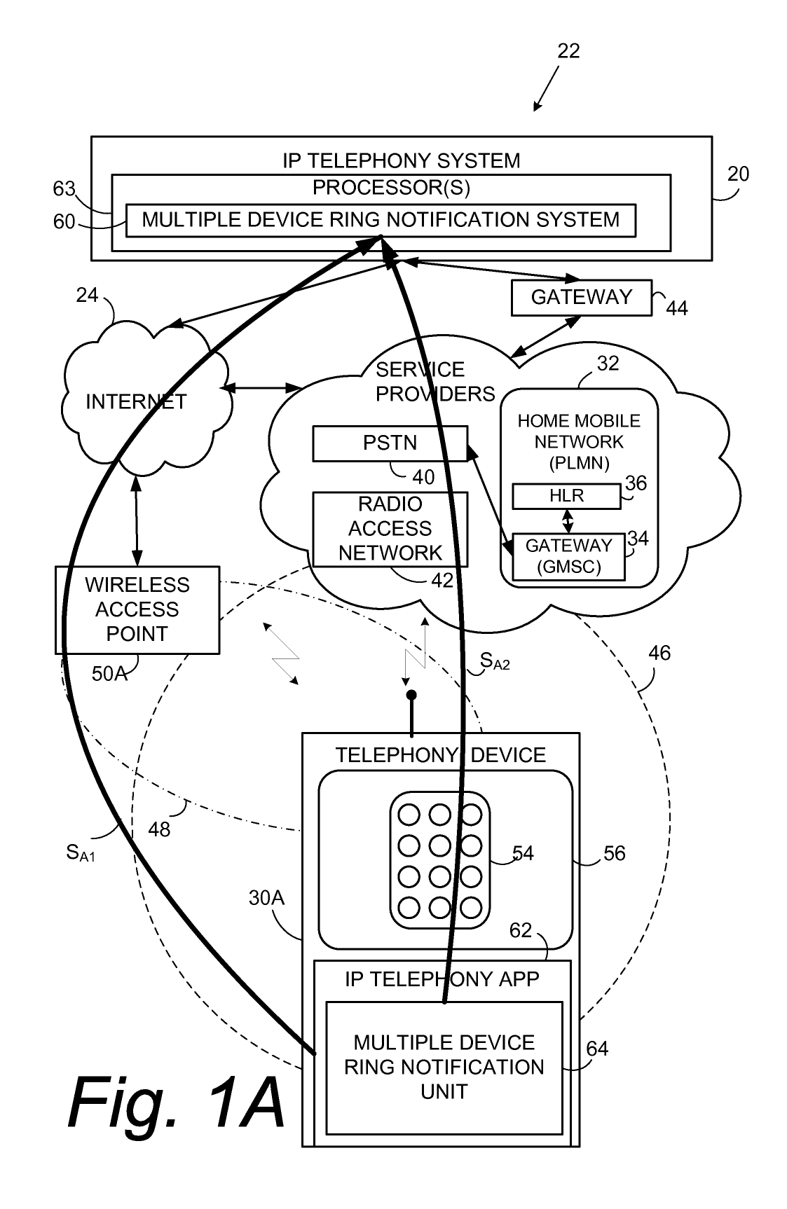

FIG. 1A shows an exemplary telephony system 20, in context of an exemplary generic communications system 22. In view of the fact that the telephony system 20 may be an Internet (IP) telephony service, the telephony system 20 is shown as connected to a data communications network 24 such as the Internet. A telephony device 30A is associated with a customer of the telephony system 20. In the example embodiment of FIG. 1A telephony device 30A is a mobile or wireless telephony device such as a user equipment unit, smart phone, or laptop or tablet with mobile termination, for example. Telephony device 30A may be used by an individual who has, or is a member of a group which has, an account or subscription with IP telephony system 20.

The customer is not only a customer of IP telephony system 20, but is also served by the customer's home mobile network 32, sometimes also known as the “home carrier” or public land mobile network (PLMN). The customer's home mobile network 32 is shown in FIG. 1 as comprising PLMN gateway or switching center (GMSC) 34, as well as a PLMN home location register (HLR) 36. The home mobile network 32 may be connected to or actually comprise the public switched telephone network (PSTN) 40. The home mobile network 32 is connected to public switched telephone network (PSTN) 40 through the PLMN gateway 34. The public switched telephone network (PSTN) 40 may be connected to or comprise one or more radio access network(s) (RANs) 42. The telephony system 20 is also connected to public switched telephone network (PSTN) 40 through one or more gateway(s) 44.

The radio access network(s) (RANs) 42 typically comprise one or more base stations which transmit and receive communications over licensed specified radio frequencies for serving wireless terminals situated in macro cells defined by the respective coverages of the respective base stations. One such example, representative macro cell 46, is shown by dashed lines in FIG. 1 as covering, e.g., a location in which wireless telephony device 30A resides, and thereby supplying radio access to wireless telephony device 30A as wireless telephony device 30A may request or require. The radio access network(s) (RANs) 42 include those such as Global System for Mobile Communications (GSM), Universal Terrestrial Radio Access Network (UTRAN), and Long Term Evolution (LTE), or any other network technologies such as GSM/EDGE and UMTS/HSPA.

FIG. 1 also shows, by dashed-dotted line, a smaller cell 48 which is served by wireless access point 50A. FIG. 1 shows wireless telephony device 30A as being within the smaller cell 48, which may be, e.g., a micro cell, pico cell, or femto cell. The wireless access point 50A may serve the wireless telephony device 30 using unlicensed frequencies, such as Wi-Fi or WiMAX. Wi-Fi is a technology that allows an electronic device to exchange data or connect to the internet wirelessly using microwaves in the 2.4 GHz and 5 GHz bands, and thus includes any wireless local area network (WLAN) products that are based on the Institute of Electrical and Electronics Engineers' (IEEE) 802.11 standards. Typically such wireless access points 50 communicate with wireless devices within their cells 48 by using unlicensed radio frequency resource(s).

FIG. 1B resembles FIG. 1A, but shows a telephony device 30B that need not necessarily require wireless access to Internet 24. FIG. 1B shows telephony device 30B as being connected by wire or cable 52 to access point 50B. Of course, the access point 50B may be capable of providing both wired and wireless access, and telephony device 30B may also be capable of wireless access to Internet 24 through access point 50B as well as capable of radio communications with radio access network(s) (RANs) 42. But in the illustration of FIG. 1B is for the purpose of illustrating scenarios in which the telephony device 30B is either not wireless, or for which wireless access is not available, or for which the user has chosen wired access over wireless access.

The technology disclosed herein concerns, e.g., methods, apparatus (either or both in an IP telephony system and in a wireless telephony device), and techniques for providing call receipt notification to multiple telephony devices of an incoming communication associated with a customer identifier. The technology disclosed herein encompasses both wireless telephony devices such as telephony device 30A of FIG. 1A and wired telephony devices such as telephony device 30B of FIG. 1B. For simplicity of explanation, all types of telephony device encompassed hereby, including wireless telephony devices such as telephony device 30 of FIG. 1A and the wired telephony devices such as telephony device 30B of FIG. 1B, will herein simply be referenced as “telephony device” or “telephony device 30”, unless otherwise specified or clear from the context.

FIG. 1A and FIG. 1B show IP telephony system 20 as comprising multiple device ring notification system 60, and telephony devices 30A and 30B as comprising IP telephony application (app) 62. The IP telephony application 62 is typically provided by the IP telephony system 20, and is executed by one or more processor(s) 63 of the telephony device 30. The processor(s) 63 of telephony device 30 is/are configured to execute computer IP telephony application 62 after the IP telephony application 62 is loaded or downloaded for storage into a non-transient computer-readable medium of telephony device 30. The IP telephony application 62 comprises instructions which are stored on the non-transient computer-readable medium and which, when executed, perform acts which participate in a multiple device ring notification list modification procedure 64 (“notification list modification procedure”) of the technology disclosed herein.

As apparent from the foregoing, telephony device 30 may be essentially any type of electronic device with telephony capabilities. The telephony device 30 may be a mobile telephony device, or may be fixed (e.g., stationary) electronic computer such as a desktop computer with telephony capabilities. In whatever form of equipment it takes, telephony device 30 comprises user input and output interfaces. In some instances the input and output interfaces may comprise a traditional keyboard and display, such as an LCD display, for example. Another example input/output device is input/output touchscreen/display screen 54 illustrated in FIG. 1A and FIG. 1B. At various times the input/output touchscreen/display screen 54 may display or otherwise depict keyboard or keypad 56. Depending on the type of equipment in which telephony device 30 is subsumed, the keypad/keyboard 56 may take one or more various forms, such as that of a QWERTY keyboard or a telephone type keypad. At other times the input/output touchscreen/display screen 54 may depict various other menus or displays, at least some of which may invite or prompt user interaction. Such interaction may be manual or stylus impulse (e.g., touch or contact with capacitive recognition/sensing), or even voice input. It should be understood that other input and output devices are also included, such as microphone and speakers.

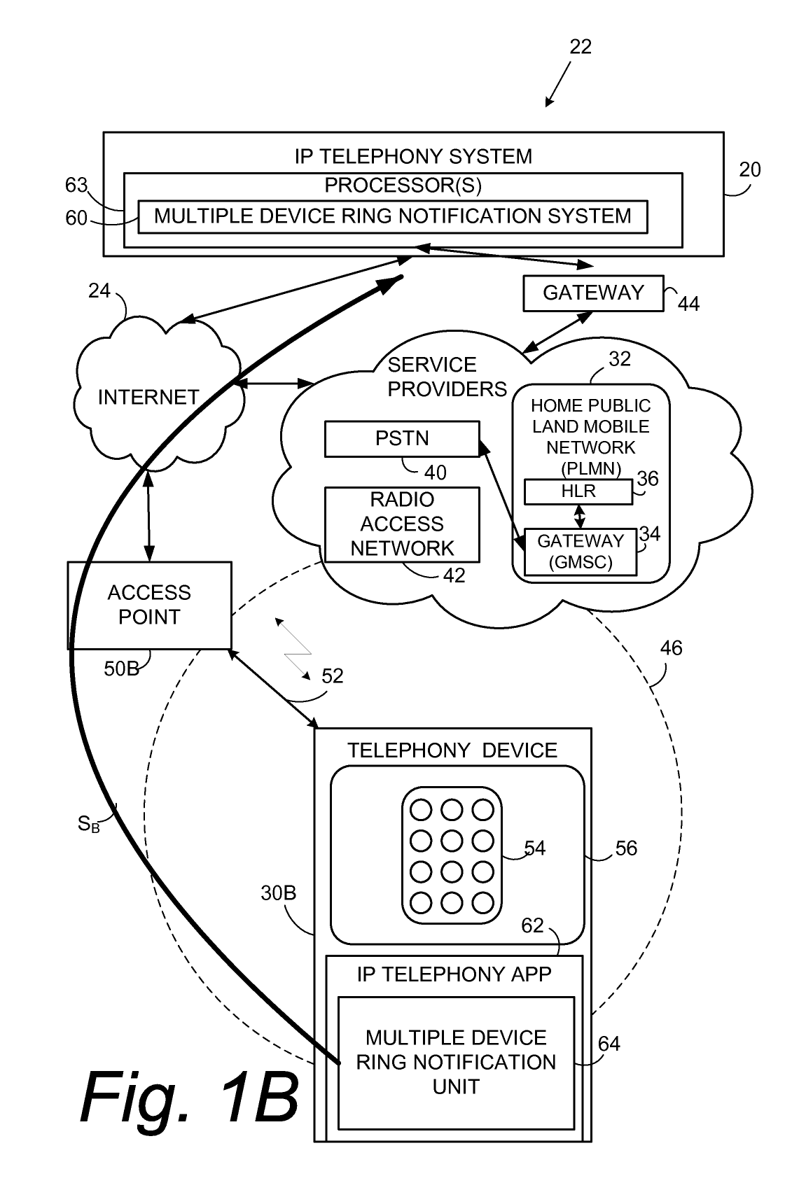

FIG. 2 shows multiple device ring notification system 60 of internet-based telephony system 20 as comprising registration unit 70 and rules engine 72. It will be appreciated that internet-based telephony system 20 comprises other units and functionalities, including but not limited to interface 74.

The registration unit 70 comprises registration database 80 and registration database manager 82. Registration database manager 82 in turn comprises authorization unit 84. The registration database 80 comprises plural customer records 86 for respective plural customers, e.g., customer record 86₁ for a first customer and customer record 86ⱼ for a j^{th} customer. Contents of the customer records 86 are described further herein.

The interface 74 of internet-based telephony system 20 comprises both signal handling unit 88 and call processing/call routing unit 89. Both signal handling unit 88 and call processing/call routing unit 89 are capable of interfacing and connection to Internet 24. The call processing/call routing unit 89 may also connect through gateway 44 (or an internal gateway) to one or more service providers, e.g., to public switched telephone network (PSTN) 40.

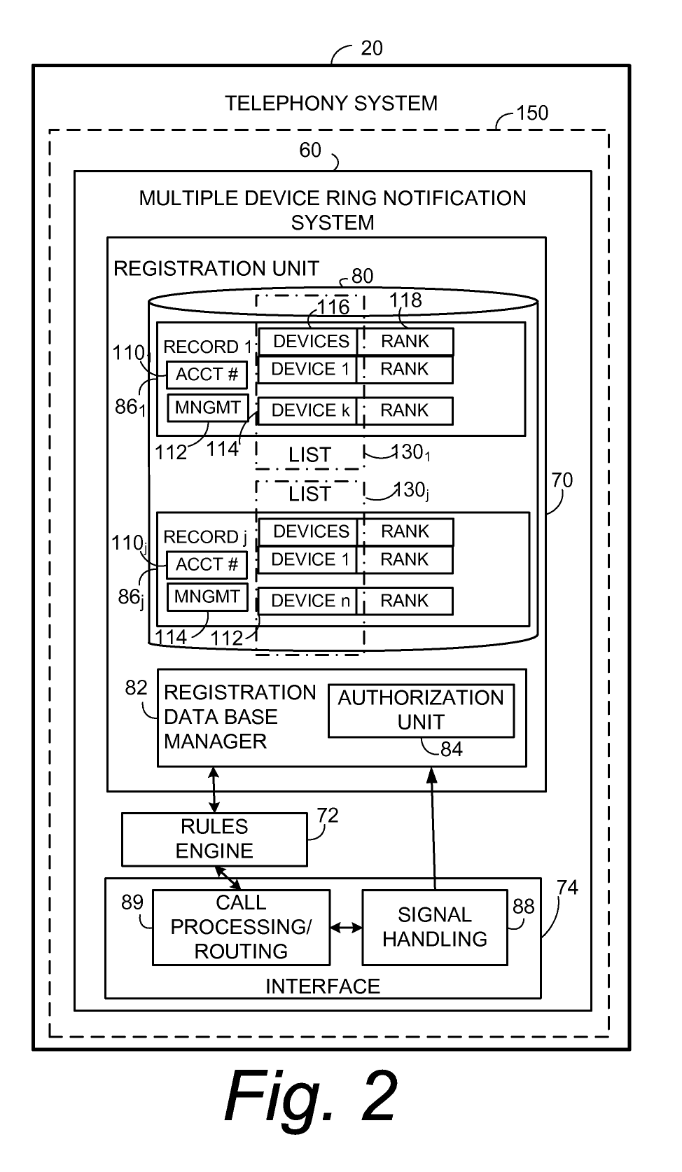

FIG. 3A shows non-limiting functionalities and/or units of a wireless telephony device 30A according to an exemplary embodiment. The example wireless telephony device 30A comprises one or more transceiver(s) 90A, which may communicate wirelessly (e.g., across a radio or air interface) to send and receive communications. Using differing communication resources and by virtue of one or more antenna, the transceiver(s) 90A may communicate with radio access network(s) (RANs) 42, typically over licensed frequencies and typically with wireless access point 50 over unlicensed frequencies, in a manner understood with reference to FIG. 1A, for example.

FIG. 3B shows non-limiting functionalities and/or units of a wired telephony device 30B according to an exemplary embodiment. The example wired telephony device 30B comprises one or more interfaces 90B for connecting by wire or cable 52 to an access point 50, in the manner of FIG. 1B, for example.

As previously mentioned, telephony device 30 (whether wired or wireless) comprises IP telephony application 62. As shown in FIG. 3A and FIG. 3B, IP telephony application 62 in turn comprises multiple device ring notification application 92 and user interface handler 94. The multiple device ring notification application 92 interacts with a user through user interfaces such as input/output touchscreen/display screen 54. To facilitate and interpret such interaction multiple device ring notification application 92 comprises user interface handler 94. Wireless telephony device 30 also comprises call processor 96, which handles both incoming and outgoing communications.

As shown in FIG. 3A and FIG. 3B, multiple device ring notification application 92 comprises notification signal generator 100 and various memories, including authentication memory 102 and options memory 104.

As mentioned above, registration database 80 of internet-based telephony system 20 includes a customer record 86 for each of plural customers 1—j of internet-based telephony system 20. Each customer record 86 comprises plural fields and sub-records, including account identifier field 110, multiple device notification management field 112, and plural sub-records 114. Each sub-record 114 represents and includes information for a different telephony device that belongs to or is associated with a customer's account. For example, for a first customer having customer record 86₁ there are k number of telephony devices and thus k number of sub-records 114; for the j^{th} customer having customer record 86j there are n number of telephony devices and thus n number of sub-records 114. In an example implementation, each sub-record 114 in turn comprises plural fields, including device identifier field 116, rank field 118, and authentication field 120. It will be appreciated that one or more of these fields 116, 118, and 120 may be optional in some embodiments.

The listing of telephony devices associated with the customer record 86 in the registration database 80 of multiple device ring notification system 60 serves as a multiple device ring notification list 130 for each customer identifier. In the illustrated embodiment, the telephony identifiers of device identifier field 116 for the various sub-records of the customer record 86 comprise the multiple device ring notification list 130. There is thus a separate multiple device ring notification list 130j for the customer of customer record 86₁ and a separate multiple device ring notification list 130j for the customer of customer record 86ⱼ. Thus, the registration unit 70 is configured to store, in association with a customer record 86, the notification list 130 of one or more telephony devices that that are to be notified upon receipt by the Internet Protocol telephony system 20 of a communication addressed to a particular customer identifier.

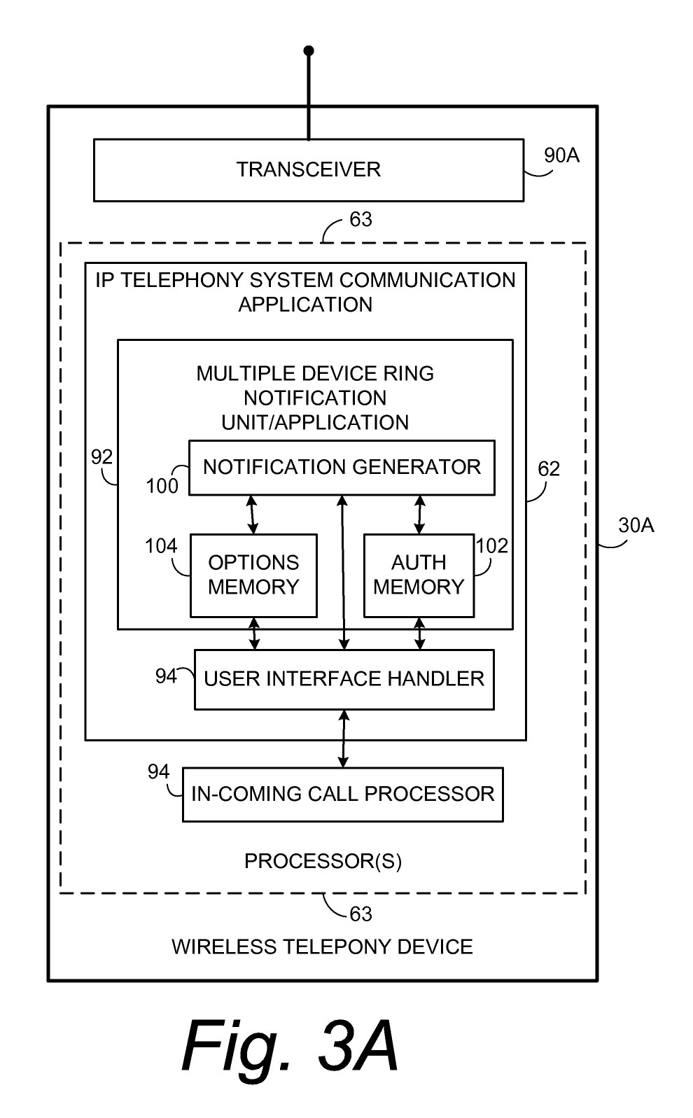

FIG. 4A shows an example multiple device ring notification list 130 for customer 1 having customer record 86₁ at a certain point in time. For the example situation shown in FIG. 4A, multiple device ring notification list 130₁ includes two telephony devices (k=2) for the customer and corresponding two fields or two members currently in multiple device ring notification list 130₁: main home telephony device field 131₁ and vacation home telephony device field 132₁. Each telephony device has its own sub-record 114 in customer record 86₁. As explained herein, the population or enumeration of telephony devices in multiple device ring notification list 130 may be dynamically changed by user interaction with an IP telephony application 62 installed on a telephony device which the user wishes to use (or discontinue use).

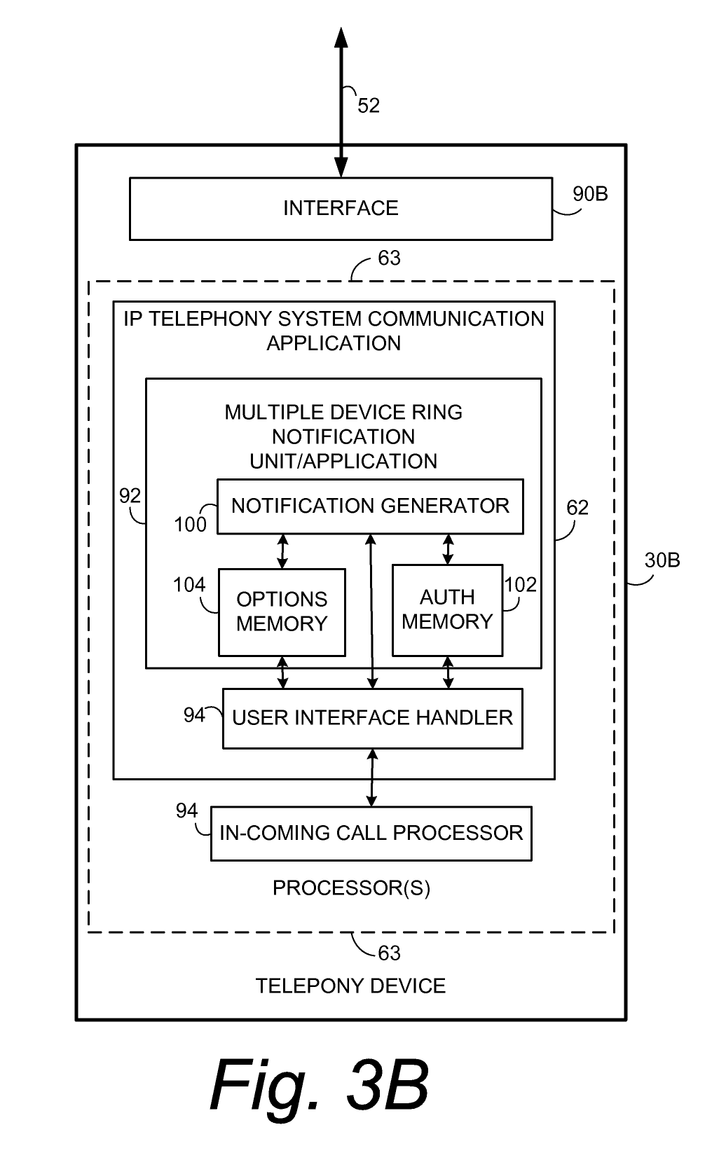

FIG. 5 shows example representative, basic acts or steps 5-1 through and including 5-6 which comprise the notification list modification procedure 64. FIG. 5 presumes that the IP telephony application 62 has been downloaded or otherwise installed into telephony device 30.

Act 5-1 comprises a user logging into (“login”) or otherwise opening/initiating execution of IP telephony application 62. Such login action of act 5-1 may involve the user touching an icon initially displayed on input/output touchscreen/display screen 54, and then in response to a login screen subsequently displayed entering a username and password, for example. In telephony device 30 the transmissions from IP registration unit 70 to multiple device ring notification system 60 are essentially handles by notification signal generator 100.

Act 5-2 comprises IP telephony application 62, after login, establishing data communications with internet-based telephony system 20, and particularly data communications with multiple device ring notification system 60. In the embodiment of FIG. 1A such data communications may include a wireless link over unlicensed frequency(ies) to wireless access point 50A, as well as data communication through Internet 24 which is received by signal handling unit 88 of internet-based telephony system 20. Alternatively, should such use of unlicensed frequency(ies) not be available, data communications may include a wireless link over licensed frequency(ies) to radio access network(s) (RANs) 42, and then data communication through public switched telephone network (PSTN) 40 and gateway 44 to signal handling unit 88 of internet-based telephony system 20. In the embodiment of FIG. 1B, on the other hand, such data communications may include data communication over wire or cable 52 to access point 50B, as well as data communication through Internet 24 which is received by signal handling unit 88 of internet-based telephony system 20.

Act 5-3 comprises IP telephony application 62 transmitting authentication credentials of telephony device 30 to internet-based telephony system 20. The authentication credentials may include any type of information that sufficiently uniquely describes or identifies the telephony device 30 or even an identifier of an installed instance of IP telephony application 62 for sake of the internet-based telephony system 20. In some example embodiments the authentication credentials may be a device identifier for the telephony device 30, or an Internet Protocol (IP) address associated with the telephony device 30. The authentication credentials may be stored in authentication memory 102 of telephony device 30.

Act 5-4 comprises IP telephony application 62 obtaining and/or transmitting to multiple device ring notification system 60 an indication of the particular multiple device ring notification list 130 to which the telephony device 30 should be added or deleted (e.g., for list modification), or for which a rank order should be modified (as described hereinafter). The transmission of act 5-4 may thus be considered a list modification signal which is sent to multiple device ring notification system 60 of internet-based telephony system 20. In other words, as act 5-4 the IP telephony application 62 obtains and/or transmits list-identifying information to multiple device ring notification system 60, e.g., specifying the particular multiple device ring notification list 130 which should be modified by inclusion or deletion of telephony device 30, or change of rank order.

As an example of the foregoing, if the user is customer 1 having customer record 86₁ shown in FIG. 2, as act 5-4 the IP telephony application 62 transmits information which specifically identifies or is associated with list 130₁ of customer record 86₁. Such specific information may be a customer account number or other customer identifier, or a particular telephone number.

In an example embodiment and mode, the information descriptive of the list 130 for which addition is sought may be entered by the user via input/output touchscreen/display screen 54 in response to a prompt, or be stored in memory. In an example embodiment and mode, the information transmitted for act 5-4 also includes an indication of the nature of the particular modification requested, e.g., either addition or deletion from the list 130. In other example embodiments and modes the multiple device ring notification system 60 may equate a logon of act 5-1 or other input as an indication of an addition modification request, and a logoff or other input as an indication of a deletion modification request.

In fact, in some example modes and embodiments, e.g., in some situations, the login of act 5-1 may include sufficient information to identify the particular multiple device ring notification list 130 for which modification is sought. In yet other situations the authentication credentials may also include information, such as account number or other customer account information, which is associated with this particular login or activation of IP telephony application 62, and be recognizable by multiple device ring notification system 60 as being a request for modification of a certain list 130. But in other situations the user may have multiple accounts or be on multiple lists 130, for which reason opportunity may be given to specify which one of the lists 130 this particular logon and transaction occurs.

Act 5-5 comprises IP telephony application 62 obtaining and/or transmitting “notification option” information to multiple device ring notification system 60. Act 5-5 is framed in broken lines to indicate that act 5-5 is an optional activity of IP telephony application 62. As further described herein, the notification option information may be used, for example, for indicating a ranking order in which the telephony device 30, once on the multiple device ring notification list 130, is to be notified (relative to other telephony devices on list 130) in the event of an incoming communication. Information concerning the options, which may be input by the user via input/output touchscreen/display screen 54 or otherwise, may be stored in options memory 104.

It should be appreciated that the acts described above may occur in a different order than described, and that some of the acts may essentially be combined in view of the fact that information mentioned in two or more separate acts may in practice be transmitted in a single act, e.g., a single signal to multiple device ring notification system 60. For example, in a basic embodiment and mode the logon of act 5-1 may automatically result in transmission of sufficient information for the multiple device ring notification system 60 to understand that the telephony device desires to enroll in the multiple device ring notification list 130.

Moreover, one or more of the transmissions described with respect to the foregoing acts may constitute a “signal” generated by notification signal generator 100 which serves a purpose of requesting that a particular multiple device ring notification list 130 be modified for sake of the telephony device 30. FIG. 1A shows an example signal S_{A1} being transmitted from telephony device 30A over unlicensed frequency(ies) to wireless access point 50A and through Internet 24 to signal handling unit 88 of internet-based telephony system 20. Alternatively, FIG. 1A also shows example signal S_{A2} being transmitted from telephony device 30A over licensed frequency(ies) to radio access network(s) (RANs) 42 and then through public switched telephone network (PSTN) 40 and gateway 44 to signal handling unit 88 of internet-based telephony system 20. FIG. 1B, on the other hand, shows example signal S_{B} being transmitted from telephony device 30B over wire or cable 52 to access point 50B and through Internet 24 for reception by signal handling unit 88 of internet-based telephony system 20.

Act 5-6 comprises multiple device ring notification system 60 performing a modification operation of the appropriate multiple device ring notification list 130 at the request of telephony device 30. Such modification is performed upon receipt by signal handling unit 88 of a signal, e.g., receipt of sufficient information to identify both the telephony device 30 making the list modification request and the particular list affected by the request. The signal handling interface 88 is thus configured to receive a signal originated by the computer application executed at a telephony device 30, e.g., multiple device ring notification application 92, which signal requests that the telephony device be included on the notification list.

In some instances the multiple device ring notification system 60 may already have associated, or have information to associate, the telephony device 30 with a particular multiple device ring notification list 130, whether still registered on that list or not. In conjunction with the registration, the authorization unit 84 of multiple device ring notification system 60 may check the authentication credentials included in the signal before authorizing registration database manager 82 to modify the requested list 130.

When the authentication credentials are accepted, the registration database manager 82 performs in registration database 80 the necessary actions to implement the list modification request, e.g., to implement either an inclusion (registration) or deletion (de-registration). For a list addition modification, the registration database manager 82 generates (or re-activates) a sub-record 114 for the telephony device 30 which has made the list modification request. In so doing, the registration database manager 82 creates and/or populates the fields of the sub-record 114. In an example embodiment and mode, such fields include device identifier field 116 and rank field 118. For a list deletion modification, the registration database manager 82 removes (or de-activates) the sub-record 114 for the telephony device 30 which has made the list modification request.

For example, in a scenario in which the telephony device 30 which makes the modification request is a mobile telephony device, the registration database manager 82 may add a new sub-record 114 to the list 130₁ of FIG. 4A, with the result that the list 130₁ of FIG. 4A is modified to become the list 130₁′ of FIG. 4B. The list 130₁′ of FIG. 4B now includes not only the main home telephony device field 131₁ and vacation home telephony device field 132₁, but now also the mobile telephony device field 133₁ which is indicative of addition of telephony device 30. On the other hand, should the telephony device 30 send a deletion modification request to multiple device ring notification system 60, the sub-record 114 associated with telephony device 30 and thus mobile telephony device field 133₁ would be deleted from list 130₁′ of FIG. 4B.

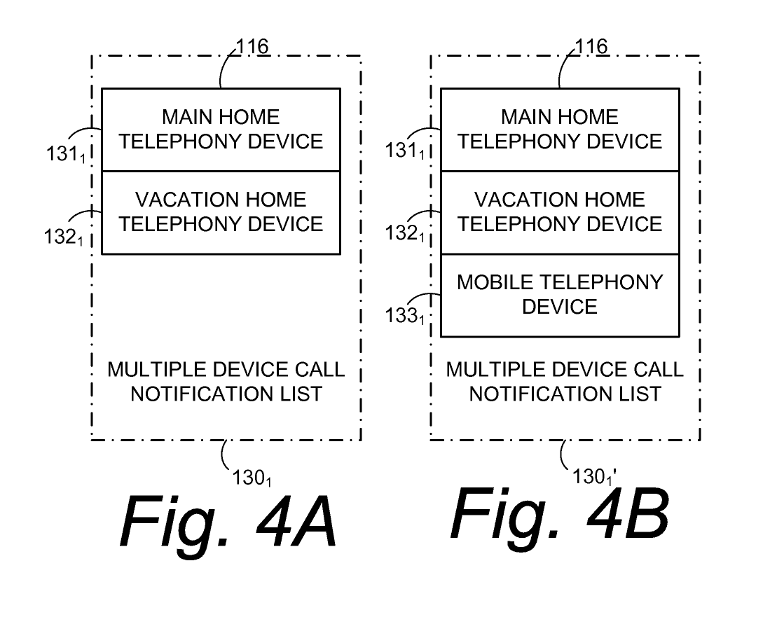

In an example embodiment and mode, the customer record 86 may take a form such as that shown in FIG. 6. In the FIG. 6 embodiment the customer record 86 also comprises account identifier field 110 and multiple device notification management field 112, and one or more sub-records 114. The sub-records 114 of the FIG. 6 embodiment comprise the device identifier field 116, rank field 118, authentication field 120 and an “on list” field 134. The “on list” field 134 indicates an indication, e.g., a “yes” or “no”, a “1” or “0” bit value, to indicate whether the telephony device identified in paired column/field device identifier field 116 is currently included on the multiple device ring notification list 130. Thus, for the FIG. 6 embodiment the multiple device ring notification list 130 may be conceptualized as being realized by the device identifier fields 116 and “on list” fields 134 of a customer record 86. In this manner, a customer may register and maintain registration of telephony devices in the account record 86, but selectively include or exclude the telephony devices on/from the multiple device ring notification list 130 without removing a telephony device from the customer record 86.

It was mentioned above in conjunction with act 5-5 that an optional activity of IP telephony application 62 may comprise obtaining and/or transmitting “notification option” information to multiple device ring notification system 60. In an example embodiment and mode, the notification option information may include an indication of ranking order of the telephony device 30 on its multiple device ring notification list 130. The notification option information is used by multiple device ring notification system 60, and by rules engine 72 in particular, in determining the order of the one or more telephony devices on the notification list 130 are to be notified in the event of an incoming communication. There are several ways, e.g., several rules, which the rules engine 72 may apply in determining the order of notification for list members.

A first rule of notification order may be that all telephony devices on list 130 are to be essentially simultaneously notified. “Essentially simultaneously” is meant that the internet-based telephony system 20 intends no delay in notification to any particular telephony device, but there may be some transmission delay due to network traffic or network conditions between the processor(s) 63 and a particular telephony device.

A second rule of notification order may be that the telephony devices on list 130 are to be notified sequentially in accordance with order of telephony device enrollment on the notification list 130. For example, in the illustration of FIG. 4B, if the telephony devices were enrolled on list 130₁′ in the order shown, e.g., main home telephone device, vacation home telephony device, and mobile telephony device, then the telephony devices would be call in that same exact order.

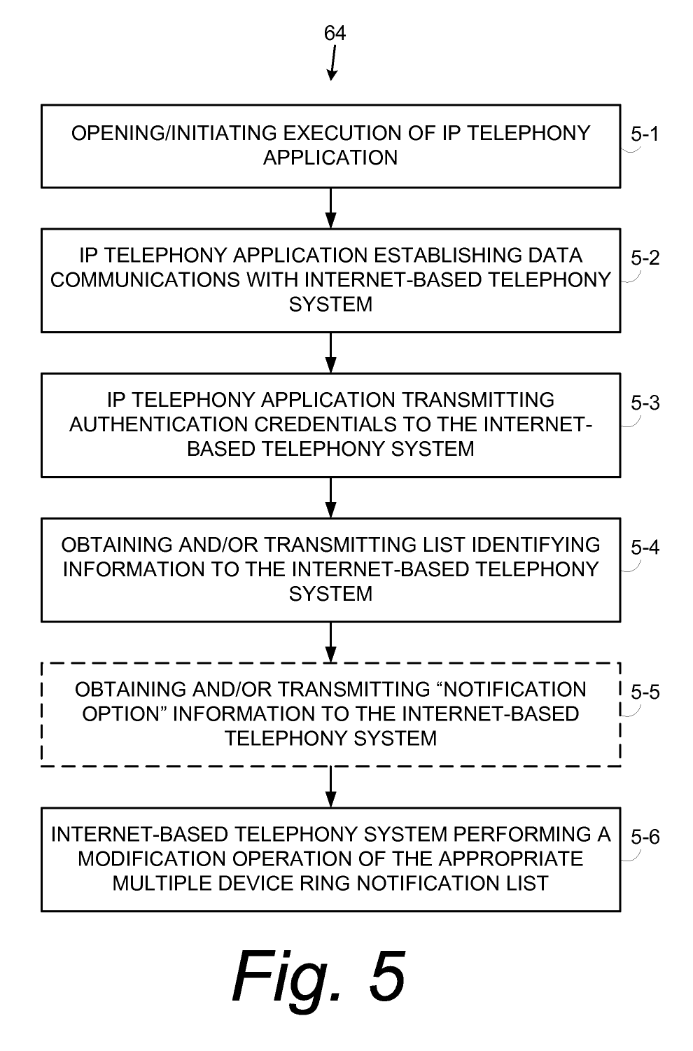

A third rule of notification order may be that the telephony devices on list 130 are to be notified sequentially in accordance with ranking order information respectively associated with the one or more telephony devices on the notification list. For example, for the situation shown in FIG. 4B, when the third rule is applicable the order notification is in accordance with rank, and such rank is reflected by the value stored in rank field 118 as shown in FIG. 7. In the example of FIG. 7, the rank fields 118 of multiple device ring notification list 130 indicate that the first telephony device to be notified is the main telephony device, and in case there is no answer at the first device the second device to be notified is the mobile telephony device, and should neither the first or second device be answered the third device to be notified is the vacation home telephony device.

It will be apparent that other order of notification rules may be developed, the foregoing serving as only non-limiting examples. Which of the particular order of notification rules is in effect for a particular customer record 86, e.g., customer, may be indicated by a value or stored in multiple device notification management field 112. For example, a “1” value stored in field 112 may indicate the first rule (simultaneous notification); a “2” value stored in field 112 may indicate the second rule (sequential in accordance with enrollment order); and a “3” value stored in field 112 may indicate the third rule (in accordance with rank).

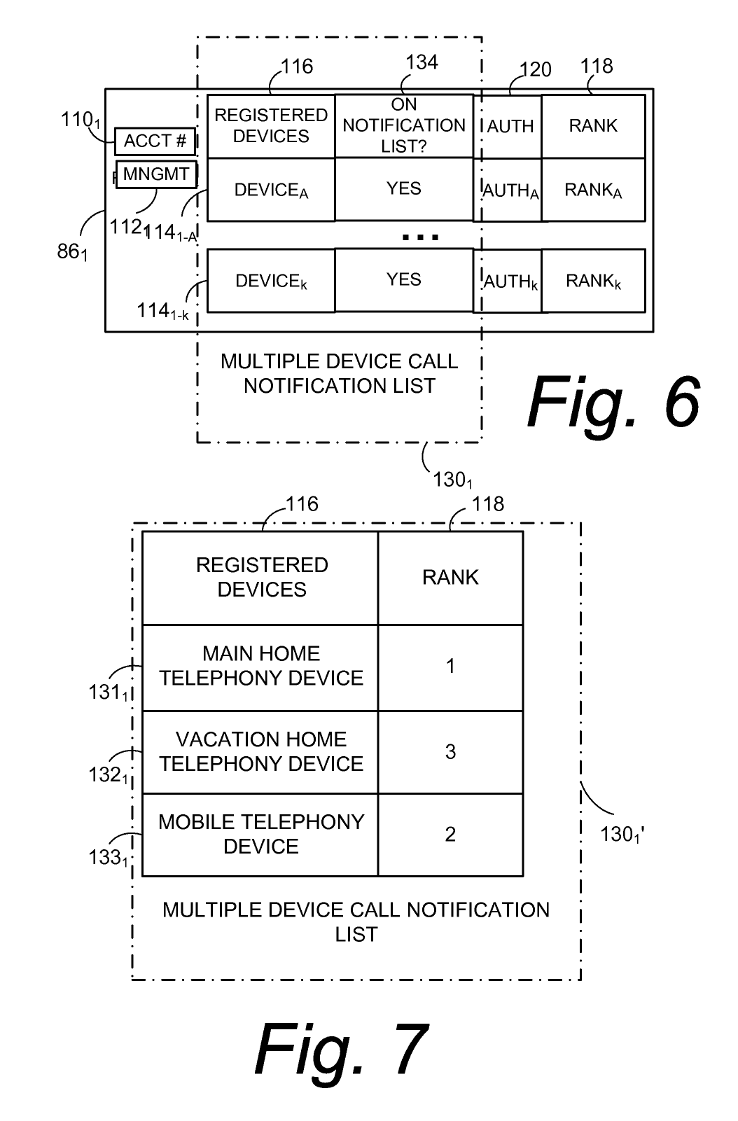

The customer may input both the value for multiple device notification management field 112, which governs all devices in the account, as well as the rank value for field rank field 118 for each respective telephony device in the account. In this respect, the multiple device ring notification application 92 may use interface handler 96 to generate on an interface (such as input/output touchscreen/display screen 54) one or more displays such as those shown in FIG. 8A and FIG. 8B. The screen of FIG. 8A includes prompts 122 for the user to enter a ranking rule type. Upon entry of the desired ranking rule type, the value is stored in options memory 104 and may be transmitted to internet-based telephony system 20 in conjunction with act 5-5 as described previously. In internet-based telephony system 20 the rule number may be stored in multiple device notification management field 112, for example.

If ranking rule type 3 is entered, the screen of FIG. 8B (or a similar screen) may be generated in order to elicit from the user a rank order for the telephony device 30. The screen of FIG. 8B shows the telephony devices which currently populate the multiple device ring notification list 130 for which the telephony device 30 seeks modification, as well as the telephony device 30 if it has not yet been entered onto the multiple device ring notification list 130. In order to generate the screen of FIG. 8B, the IP telephony application 62 must fetch from registration unit 70 identifications of the other telephony devices already included in the customer record 86 for the affected list 130, and includes indications of those other telephony devices and their current ranks in the display. For the screen of FIG. 8B, the user then may select a particular device for which rank is to be modified, and then adjust (up or down) an existing rank value for the selected telephony device. The resultant input generates notification option information which is stored in options memory 104 and may be transmitted to internet-based telephony system 20 in conjunction with act 5-5 as described previously. In internet-based telephony system 20 the rank order for any affected telephony devices may be stored in the associated rank field 118, for example.

Thus, in executing the multiple device ring notification application 92 in conjunction with the display of FIG. 8B the processor(s) 63 is/are configured to receive a constituency of other telephony devices already included on the list 130 and to provide the constituency to the user on the user interface 54, and also to receive through the user interface 54 an indication of ranking order of the telephony device relative to the constituency of other telephony devices.

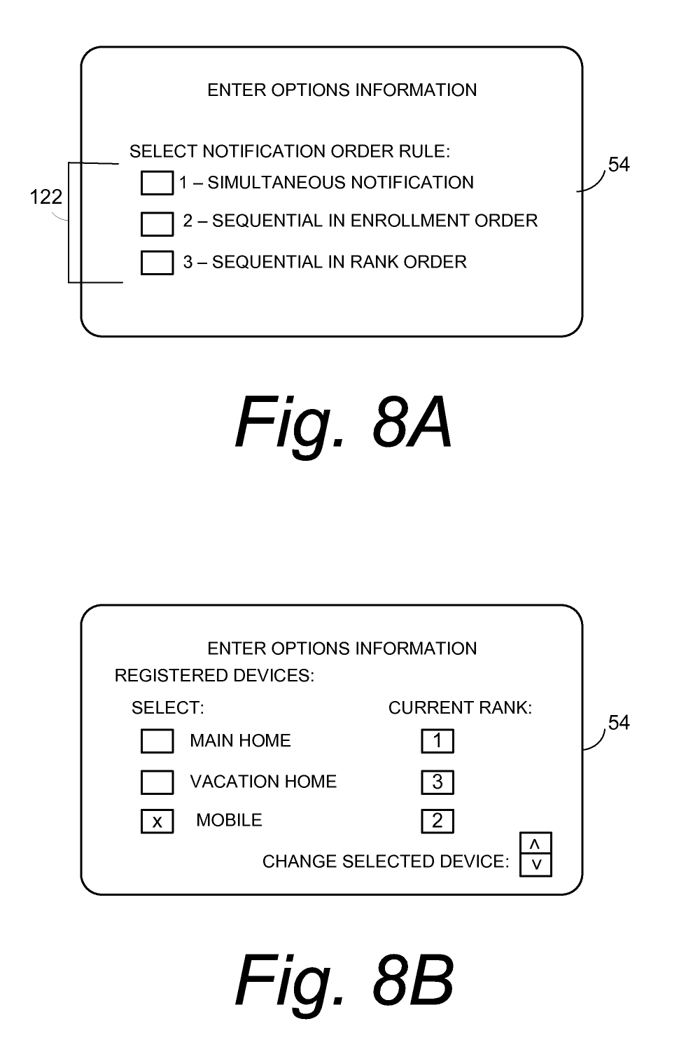

FIG. 9 shows basic, representative, non-limiting and non-exhaustive exemplary acts or steps comprising an incoming communication processing procedure 124 performed by internet-based telephony system 20 in accordance with an exemplary embodiment and mode. The incoming communication is first received by call processing/call routing unit 89. The call processing/call routing unit 89 notes that the incoming communication is addressed to or pertains to a particular customer identifier (e.g., customer telephone number) for which internet-based telephony system 20 maintains an account. The call processing/call routing unit 89 then consults rules engine 72 to determine how the incoming communication should be handled.

The rules engine 72 may have several different types of rules to apply for processing the incoming communication. For example, the customer may have implemented a call forwarding feature or call blocking rules for certain incoming communications. Among these and potentially other rules the rules engine 72 checks to see if the customer is also enrolled in the multiple device ring notification system 60. If so, in act 9-1 the rules engine 72 obtains from the customer record 86 the appropriate information for developing a strategy for notifying the telephony devices on the multiple device ring notification list 130. In its basic form, such information includes not only the identity of the telephony devices on the list (from device identifier fields 116), but also the notification order rule (from multiple device notification management field 112). As described before, the notification order rule may be any one of several rules, including but not limited to simultaneous notification, sequential notification in enrollment order, and sequential notification in rank order. If notification order rule indicates notification according to sequential notification in rank order, the rules engine 72 also obtains (from rank field 118) the rank for each of the telephony devices on the multiple device ring notification list 130. The information obtained from customer record 86 is used by rules engine 72 as rules logic to direct the strategy for further processing the incoming communication by call processing/call routing unit 89.

Act 9-2 shows the call processing/call routing unit 89 implementing the strategy developed by rules engine 72 for routing notifications to the one or more telephony devices which populate the multiple device ring notification list 130. The notification routing strategy is essentially in accordance with the notification order rule.

For example, if the first rule is in effect for the customer, all telephony devices on the multiple device ring notification list 130 are simultaneously notified. If the second rule is in effect, the telephony devices on multiple device ring notification list 130 are sequentially notified in order of their (historical or chronological) enrollment. That is, if a first or earliest enrolled telephony device does not answer, the next eldest enrolled telephony device is notified, and so on until a telephony device answers the notification. If the third rule is in effect, the telephony devices on multiple device ring notification list 130 are notified in accordance with their ranking order until one of the telephony devices responds or answers.

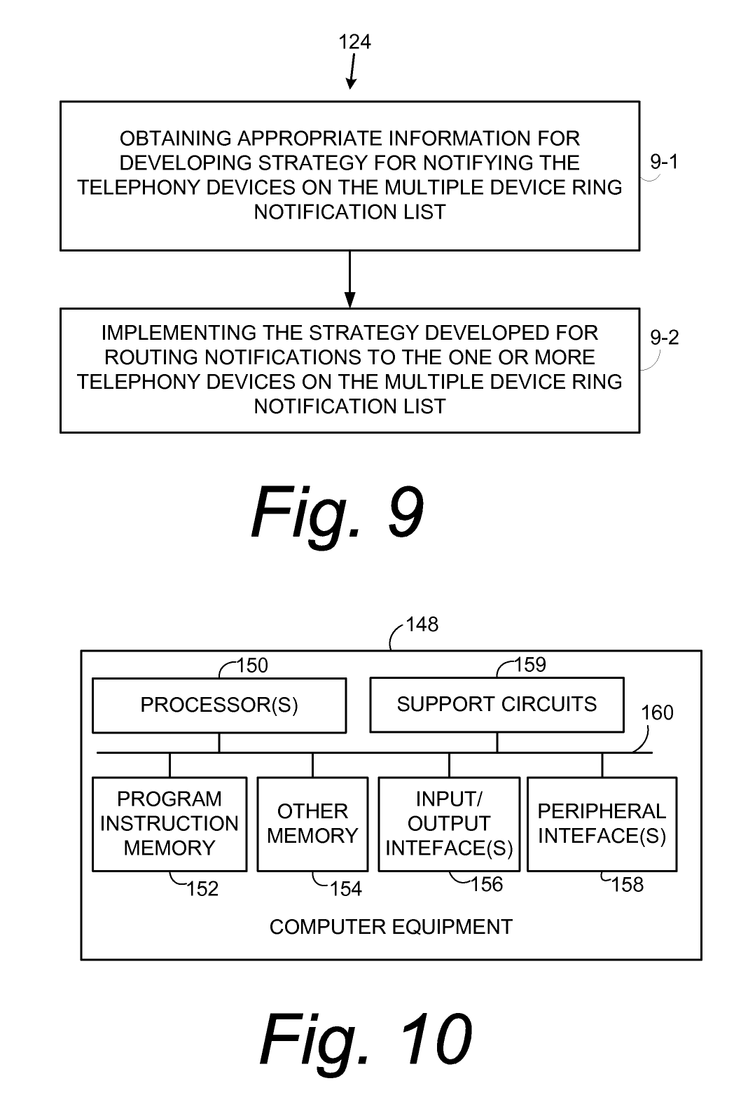

Functions described herein, including the multiple device ring notification system 60 of IP telephony system 20 and the IP telephony application 62 of wireless telephony device 30 (including multiple device ring notification application 92) may, at least in some embodiments and modes, be performed by machine hardware 148. FIG. 10 shows an example of such machine hardware as comprising one or more processors 150 (which could be processor(s) 63 of telephony device 30) , program instruction memory 152; other memory 154 (e.g., RAM, cache, etc.); input/output interfaces 156; peripheral interfaces 158; support circuits 159; and busses 160 for communication between the aforementioned units.

The memory 154, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 159 are coupled to the processors 150 for supporting the processor in a conventional manner. These circuits include cache, power supplies, clock circuits, input/output circuitry and subsystems, and the like.

Software routines such as software for multiple device ring notification system 60 of IP telephony system 20 and software for IP telephony application 62 (including multiple device ring notification application 92) of wireless telephony device 30 may be computer program products which include coded instructions stored on non-transient medium and which are executed by processors 150/63 of the IP telephony system 20 and wireless telephony device 30, respectively, for performing the acts described herein. For the machine hardware 148 of each of IP telephony system 20 and wireless telephony device 30 such software/computer program products may be stored on non-transient memory such as program instruction memory 152. Also, the software routines could also be stored remotely from the CPU, e.g., remotely from processors 150/63. For example, the software could be resident on servers and memory devices that are located remotely from the CPU, but which are accessible to the CPU via a data network connection. Such software, when executed by processors 150, transforms the general purpose computer into a specific purpose computer that performs one or more functions of the IP telephony system 20 or telephony device 30. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the exemplary hardware recited above.

The technology disclosed herein has many advantages. Using the technology disclosed herein a user can login into various devices through, for example, a software interface (e.g., login to multiple device ring notification application 92 via input/output touchscreen/display screen 54) on those devices. As explained above, in some example embodiments and modes even the logon itself may trigger dynamic addition of the telephony device to the multiple device ring notification list 130 (and, conversely logoff may dynamically remove the telephony device from the list 130. Thus, user choices for the multiple device ring notification list 130 may be conveniently and intuitively entered at the endpoint, e.g., on the very telephony device for which modification of the multiple device ring notification list 130 is sought. Subsequent incoming communications will cause the telephony device to be rung (or, if the incoming communication is a text message, “text-messaged”) in accordance with the rules established for the multiple device ring notification list 130.

Thus, the technology disclosed herein provides dynamic modification of a multiple device ring notification list, which dynamic modification may be initiated and controlled by the very telephony device which is involved in the modification (e.g., the telephony device which is to be added, deleted, or have options modified/changed on the list). Moreover, the dynamic modification may be initiated and controlled by a computer software program product, e.g., an application such as multiple device ring notification application 92, which executes on the affected telephony device.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An Internet Protocol telephony system comprising:
a registration unit configured to store, in association with a customer record, a notification list of one or more telephony devices that that are to be notified upon receipt by the Internet Protocol telephony system of a communication addressed to a customer identifier corresponding to the customer record;
a signal handling interface configured to receive a signal originated by a telephony device;
a rules engine configured to consult the notification list and apply rules logic to determine in what order the one or more telephony devices on the notification list are to be notified; and
a call processing interface configured to route notifications to the one or more telephony devices.

2. The system of claim 1, wherein the signal handling interface is configured to receive a signal originated by a computer application executed at a telephony device, the signal requesting that the notification list be modified with respect to the telephony device; and wherein the rules engine is configured to consult the notification list and to apply the rules logic upon receipt by the Internet Protocol telephony system of the communication addressed to the customer identifier corresponding to the customer record.

3. The system of claim 1, wherein the signal is configured to add the telephony device to the customer record.

4. The system of claim 1, wherein the signal is configured to control the notification list.

5. The system of claim 1, wherein the signal is configured to request one of the following: (1) that the telephony device be included on the notification list; (2) that the telephony device be removed from the notification list; and (3) that a ranking order of the telephony device on the list be modified.

6. The system of claim 1, wherein the rules logic requires that the one or more telephony devices be essentially simultaneously notified.

7. The system of claim 1, wherein the rules logic requires that the one or more telephony devices be notified sequentially in accordance with ranking order information respectively associated with the one or more telephony devices on the notification list.

8. The system of claim 1, wherein the rules logic requires that the one or more telephony devices be notified sequentially in accordance order of telephony device enrollment on the notification list.

9. The system of claim 1, wherein at least one or more of the registration unit, the signaling handling interface, the rules engine, and the call processing interface are implemented by a computer processor.

10. A telephony device comprising:
a processor configured to generate a signal configured to control a notification list maintained by an Internet Protocol telephony system with respect to the telephony device, the notification list being of one or more devices that are to be alerted upon receipt by the Internet Protocol telephony system of a communication addressed to a particular customer identifier;
an interface configured to transmit the signal to the Internet Protocol telephony system.

11. The telephony device of claim 10, wherein the signal is further configured to add the telephony device to a customer record associated with the particular customer identifier.

12. The telephony device of claim 10, wherein the signal is configured to prompt the Internet Protocol telephony system to perform a modification of the notification list.

13. The telephony device of claim 12, wherein the modification is one of the following: (1) including the telephony device on the notification list; (2) removing the telephony device from the notification list; and (3) changing a ranking order of the telephony device on the notification list.

14. The telephony device of claim 10, wherein the interface is a transceiver configured to transmit the signal to a wireless access point which is in data communication with the Internet Protocol telephony system and, after the telephony device has been included on the notification list, to receive an incoming communication addressed to the particular customer identifier.

15. The telephony device of claim 10, further comprising a user interface, and wherein the processor is configured to execute a computer application comprising instructions stored on non-transient computer-readable medium, wherein the user interface facilitates user interaction with the application.

16. The telephony device of claim 15, wherein the processor is configured to include computer application authentication information in the signal.

17. The telephony device of claim 15, wherein the processor is configured to register the computer application authentication information with the Internet Protocol telephony system upon installation of the computer application.

18. The telephony device of claim 15, wherein the user interface is configured to request notification option information from the user, and wherein the processor is configured to include the notification option information in at least one or more of the signal and another signal to the Internet Protocol telephony system.

19. The telephony device of claim 18, wherein the notification option information includes an indication of ranking order of the telephony device on the notification list.

20. The telephony device of claim 19, wherein the processor is configured to receive a constituency of other telephony devices already included on the notification list and to provide the constituency to the user on the user interface, and to receive through the user interface an indication of ranking order of the telephony device relative to the constituency of other telephony devices.

21. A method of operating a communications network via an Internet Protocol telephony system comprising:
receiving a signal generated by a telephony device, the signal configured to control a notification list, the notification list being of one or more telephony devices that are to be alerted upon receipt by the Internet Protocol telephony system of a communication addressed to a particular customer identifier;
upon receipt of the signal, performing the modification of the notification list in accordance with the request; and
upon receipt of the communication addressed to the particular customer identifier, routing a notification of the communication to one or more telephony devices on the notification list.

22. The method of claim 21, wherein the signal is further configured to add the telephony device to a customer record associated with the particular customer identifier.

23. The method of claim 21, wherein the signal is configured to the signal configured to prompt modification of the notification list.

24. The method of claim 21, wherein the modification is one of the following:
(1) including the telephony device on the notification list; (2) removing the telephony device from the notification list; and (3) changing a ranking order of the telephony device on the notification list.

25. The method of claim 21, wherein the signal is configured to request one of the following: (1) that the telephony device be included on the notification list; (2) that the telephony device be removed from the notification list; and (3) that a ranking order of the telephony device on the notification list be modified.
